(19) United States
(12) Patent Application Publication
(10) Pub. No.: US 2010/0220712 A1
(43) Pub. Date: Sep. 2, 2010

(54) METHOD FOR IMPROVING SYNCHRONIZATION PRECISION OF DATA TRANSMISSION AND SYSTEM THEREOF

(75) Inventors: Mingsheng Zhang, Guangdong (CN); Shengwen Xiang, Guangdong (CN)

Correspondence Address: ROSENBERG, KLEIN & LEE, 3458 ELLICOTT CENTER DRIVE-SUITE 101, ELLICOTT CITY, MD, 21043, US

(73) Assignee: SHENZHEN GRENTECH CO., LTD., GUANGDONG (CN)

(21) Appl. No.: 12/682,160

(22) PCT Filed: Jul. 28, 2008
(86) PCT No.: PCT/CN08/71784

§ 371 Date: Apr. 8, 2010

(30) Foreign Application Priority Data
Oct. 16, 2007 (CN) 200710123943.3

(51) Int. Cl. H04J 3/06

(52) U.S. Cl. 370/350

(57) ABSTRACT

A method for improving synchro precision of data transmission and system thereof are disclosed. The method includes the following steps: RRU receives a data frame and buffers; frame-parses to a wireless frame impulse signal and a carrier wave data signal of the data frame, setting the maximum time-lapse compensating time; a time-lapse is redeemed to the wireless frame impulse signal after parsing, according to the time of transmission and buffering, and the maximum time-lapse compensating time, and then sends to the communication port of RRU to transmit; a time-lapse is redeemed to the carrier wave data signal after parsing, according to the time of transmission and buffering, the maximum time-lapse compensating time, and transmission time of processing data, the carrier wave data is processed, and then is sent to the communication port of RRU to transmit; the wireless frame impulse signal and the carrier wave data signal are sent to the communication port of RRU simultaneously. The solution redeems the carry time-lapse for transmission data, so that the redeeming precision can reach multiple seconds, thus improving synchro precision of the data in an effective manner.

### TECHNICAL FIELD

The present invention relates to the field of communications, and in particular to a method for improving synchronization precision of data transmission and a system thereof.

### BACKGROUND OF THE INVENTION

In the TD-SCDMA system, the required synchronization precision of air interface is ⅛ chip width, i.e. about 100 ns. In the base station model of the baseband unit (BBU) plus the remote radio unit (RRU), synchronization precision of the air interface is determined by the precision of fiber delay measurement and the precision of synchronization delay compensation of the air interface.

However, the precision of the fiber delay measurement is limited by the current technique condition. Normally, the precision is relative low, and it is difficult to improve the measurement precision. In the case of multi-level RRU concatenation, the fiber delay measure error of the optical fiber link is relative large.

A high-precision delay compensation method is thus significant for use in the delay processing of the air interface synchronization. To improve the synchronization precision of the air interface, it is necessary to adjust the precision of the delay compensation of data transmission.

### SUMMARY OF THE INVENTION

It is an object of the present invention to provide a method for improving synchronization precision of data transmission and a system thereof.

The above object of the present invention is achieved by the following technical solutions:

a method for improving synchronization precision of data transmission, comprises:

receiving and buffering a data frame by a remote radio unit (RRU);

performing frame parsing to a wireless frame impulse signal and a carrier data signal of the data frame, and setting the maximum delay compensation time;

performing delay compensation to the wireless frame impulse signal after the frame parsing, according to the transmission and buffering time and the maximum delay compensation time, to generate a transmission control signal, which is then sent to a communication port of the RRU for transmitting;

performing delay compensation to the carrier data signal after the frame parsing, according to the transmission and buffering time, the maximum delay compensation time and the data processing and transmission time, processing the carrier data, and then the carrier data signal being sent to the communication port of the RRU for transmitting; wherein the wireless frame impulse signal and the carrier data signal are sent to the communication port of the RRU simultaneously.

Wherein, the delay compensation time to the wireless frame impulse signal is equal to the time obtained by subtracting the transmission and buffering time from the maximum delay compensation time;

the delay compensation time to the carrier data signal is equal to the time obtained by subtracting the transmission and buffering time and the data processing and transmission time from the maximum delay compensation time.

Wherein, the data frame is transmitted from the signal output port of the baseband unit (BBU) to the signal input port of the RRU and buffered;

frame parsing is performed to the wireless frame impulse signal and the carrier data signal of the data frame, and the maximum delay compensation time is set;

delay compensation is performed to the wireless frame impulse signal, according to the transmission and buffering time and the maximum delay compensation time, to generate a radio frequency control signal, which is then sent to the antenna transmit port;

time compensation is performed to the carrier data signal, according to the transmission and buffering time, the maximum delay compensation time, the DUC (digital up conversion) processing time, the DAC (digital analog conversion) processing time, and the radio frequency module transmission time, and DUC processing and DAC processing are performed to the carrier data, and then the carrier data is sent to the antenna transmission port via the radio frequency module; wherein the wireless frame impulse signal and the carrier data signal are sent to the antenna receive port simultaneously.

Wherein after the data frame is transmitted from the signal output port of the baseband unit to the signal input port of the RRU and buffered, the data frame of the baseband unit or the previous RRU is transmitted to the next RRU.

Wherein, the data frame is received by the antenna receive port of the RRU, and transmitted to the radio frequency module;

frame parsing is performed to the wireless frame impulse signal and the carrier data signal of the data frame, and the maximum delay compensation time is set;

delay compensation is performed to the wireless frame impulse signal, according to the time for the data frame to be transmitted and buffered to the BBU and the maximum delay compensation time, and then the wireless frame impulse signal is buffered to the signal output port of the RRU and transmitted to the signal input port of the BBU;

ADC (analog digital conversion) processing and DDC (digital down conversion) processing are performed to the carrier data signal; delay compensation is performed to the carrier data signal according to the radio frequency module transmission time, the ADC processing time, the DDC processing time, the maximum delay compensation time and the transmission and buffering time; ADC processing and DDC processing are performed to the carrier data which is then buffered to the signal output port of the RRU and transmitted to the signal input port of the BBU; wherein the wireless frame impulse signal and the carrier data are sent to the signal output port of the RRU simultaneously.

Wherein, after the wireless impulse signal and the carrier data signal are buffered to the signal output port of the RRU, framing is performed to the current data frame and the next uplink data frame, and transmitted to the previous RRU or the BBU.

Wherein, the maximum delay compensation time is in a range of 0-10 ms.

A system for improving synchronization precision of data transmission, comprises: a RRU; and a BBU for transmitting data frame to the RRU and receiving data frame from the RRU; wherein the RRU comprises:

a receiving unit for receiving the data frame and buffering and for performing frame parsing to a wireless frame impulse signal and a carrier data signal of the data frame;

a delay compensation unit for performing delay compensation to the wireless frame impulse signal after the frame parsing, according to the transmission and buffering time and the maximum delay compensation time, and also for performing delay compensation to the carrier data signal after the frame parsing, according to the transmission and buffering time, the maximum delay compensation time and the data processing and transmission time;

a communication unit for transmitting the wireless frame impulse signal and also for processing and transmitting the carrier data; wherein the wireless frame impulse signal and the carrier data signal are transmitted simultaneously.

Wherein, in the delay compensation unit, the delay compensation time to the wireless frame impulse signal is equal to the time obtained by subtracting the transmission and buffering time from the maximum delay compensation time; and the delay compensation time to the carrier data signal is equal to the time obtained by subtracting the transmission and buffering time and the data processing and transmission time from the maximum delay compensation time.

Wherein, the receiving unit is the signal input port of the RRU, the communication unit comprises the antenna transmission port; alternatively, the receiving unit is the antenna transmission port, the communication unit comprises the signal input port of the RRU.

It can seen from the above technical solution that after receiving the uplink or downlink data frame, frame parsing is performed to the wireless frame impulse signal and the carrier data which are then processed with delay compensation to enable the carrier data can be sent out simultaneously when the wireless frame impulse arrives. With the present invention, the precision of delay compensation reaches several nano-seconds, which greatly improves the precision of data synchronization.

### BRIEF DESCRIPTION OF THE DRAWINGS

FIG. 1 is a basic flow chart of the method according to the present invention;

FIG. 2 is a schematic diagram of the delay processing of downlink synchronization in the method of the present invention;

FIG. 3 is a structural diagram of the system of the present invention.

### DETAILED DESCRIPTION OF THE PREFERRED EMBODIMENT

Many aspects of the present invention will be described in detail with reference to the accompanying drawings.

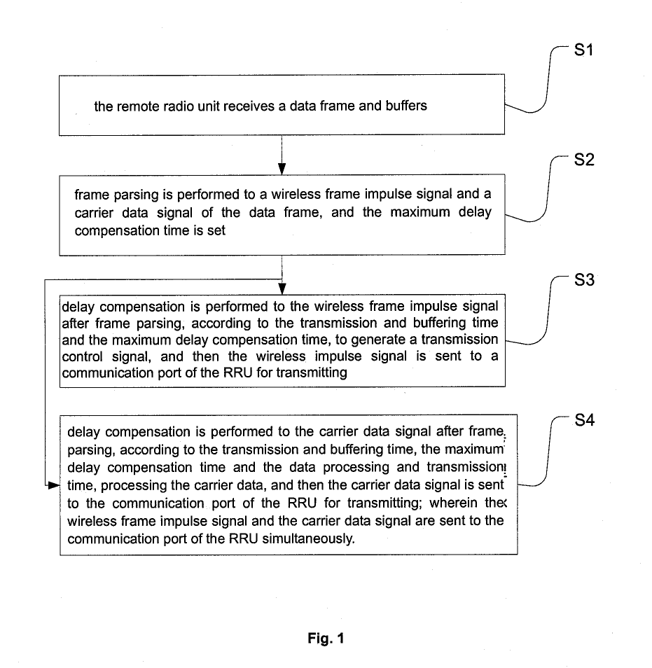

In order to realize the delay compensation to the communication data, and to improve the synchronization precision of the air interface, the present invention provides a method for improving the synchronization precision of data transmission, as shown in FIG. 1, the method comprises:

Step S1, a data frame is received and buffered by the RRU (Radio Remote Unit).

Step S2, frame parsing is performed to a wireless frame impulse signal and a carrier data signal of the data frame, and the maximum delay compensation time is set. The wireless frame impulse signal and the carrier data after the frame parsing are respectively processed in Step S3 and Step S4.

Step S3, delay compensation is given to the wireless frame impulse signal after the frame parsing, according to the transmission and buffering time and the maximum delay compensation time, and then the wireless impulse signal is sent to a communication port of the RRU for transmitting;

Step S4, delay compensation is given to the carrier data signal after the frame parsing, according to the transmission and buffering time, the maximum delay compensation time and the data processing and transmission time, the carrier data is processed and then sent to the communication port of the RRU for transmitting; wherein the wireless frame impulse signal and the carrier data signal are sent to the communication port of RRU simultaneously.

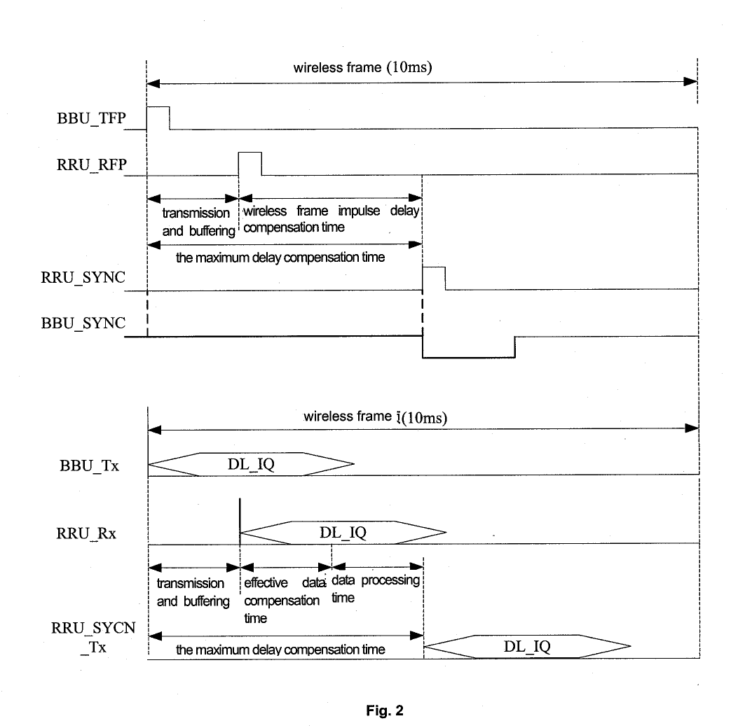

With reference to FIG. 2, the working process and principle will be explained, taking the downlink synchronization for instant:

Above all, the data frame containing the wireless frame impulse signal and the carrier data is sent to and buffered in the signal input port of the RRU by the signal output port of the BBU (Baseband Unit).

For the 10 ms wireless frame impulse signal BBU_TFP of the transmitted data of the optical interface of the BBU, this signal should be generated according to the reference wireless frame impulse signal of the BBU air interface, that is, the BBU_TFP is at a fixed time interval ahead of the reference wireless frame impulse signal of the BBU air interface. The reference wireless frame impulse signal BBU_SYNC of the BBU air interface is a reference wireless frame impulse signal for air interface synchronization generated at the BBU, and it is used for inspecting whether the air interface synchronization between the BBU and all levels of RRU is established. As for the 10 ms wireless frame impulse signal RRU_RFP recovered by the RRU from the fiber downlink, the delay value of the RRU_RFP relative to the BBU_TFP is the time T12 for transmitting and buffering data from the BBU end to the RRU end.

Then, time delay processing is made according to the RRU_RFP signal of the current RRU, the adjustment value is the impulse delay compensation time DL_radio_frame_Delay, a wireless frame impulse signal of air interface synchronization RRU_SYNC is generated so as to allow the synchronization (the edges are aligned) between the reference wireless frame impulse signal of the BBU air interface and the wireless frame impulse signal of the RRU air interface, that is, the time delay value relative to the BBU_TFP is the maximum delay compensation time Fixed_Delay. In this way, the wireless frame impulse signal of the RRU air interface of all levels of RRU can be synchronized, the antenna transmit-receive (TR) switch signal of RRU is generated according to the RRU air interface synchronous wireless frame impulse signal. The impulse delay compensation time of the downlink wireless frame is equal to that obtained by subtracting the transmission and buffering time T12 from the maximum delay compensation time Fixed_Delay, that is:

DL_radio_frame_Delay=Fixed_Delay−T12

When the uplink fiber and the downlink fiber are equal in length, the transmission and buffering time T12 from the BBU end to the RRU end is equal to the transmission and buffering time T34 from the RRU end to the BBU end, and by measuring the 10 ms wireless frame time difference Toffset between the input signal end and the output signal end of the RRU, and by measuring the 10 ms wireless frame time difference T14 between the output signal end and the input signal end of the RRU, the T12 or T34 is calculated from the following formula:

T14=T12+Toffset+T34

For the carrier data, the downlink carrier IQ data BBU_Tx is transmitted by the optical interface of the BBU end, the downlink carrier IQ data RRU_Rx is received by the optical interface of the RRU. A fixed maximum delay compensation time Fixed_Delay is appointed between the BBU and the RRU, the fixed maximum delay compensation time is equal to the maximum delay compensation time of the wireless frame impulse signal, and the total time delay of the downlink data from the optical interface of the BBU end to the antenna interface of the RRU end is Fixed_Delay; the total time delay of the uplink signal received by the antenna interface of the RRU end to the optical interface of the BBU end is also Fixed_Delay.

Then, time delay processing is made with respect to the carrier data received by the optical interface of the RRU end, the adjustment value is the delay compensation time of the carrier data DL_IQ_Delay, the carrier data after the time delay processing is processed by the Digital Up Converter (DUC) and the Digital Analog Converter (DAC) and transmitted by the RF Module, and when it is transmitted to the antenna interface of the RRU, the carrier data is synchronous with the RRU_SYNC. The DUC processing time, the DAC processing time, and the RF Module transmitting time may be set according to the practice, and the total time of these three parts is the data processing and transmission time T2a. After the time delay compensation, the downlink carrier signal RRU_SYNC_Tx can be transmitted via the antenna interface of the RRU end.

The adjustment value DL_IQ_Delay of the delay compensation time of the carrier data is equal to the value obtained by subtracting the transmission and buffering time T12 and the data processing and transmission time T2a from the maximum delay compensation time, that is:

DL_IQ_Delay=Fixed_Delay−T12−T2a

All the above time delay adjustment values are calculated by the CPU of the RRU end, and converted into the adjustment value format required by the FPGA and transmitted to the FPGA, the wireless frame impulse signal and the carrier data signal and the RRU_RFP are then delayed for the DL_radio_frame_Delay by the FPGA according to the transmitted time delay information to obtain the RRU_SYNC, so as to generate antenna transmit-receive (TR) switch signal of the RRU; the downlink carrier data extracted from the optical interface via the RAM by the FPGA is buffered DL₁₃IQ_Delay, and then transmitted to the DUC module for subsequent processing.

The above discussion relates to the downlink synchronization delay processing when the BBU is connected with a single level of RRU, and the uplink time delay processing is similar.

Regarding other network structures under multi-level RRU, such as chain network and tree network, it is necessary to further increase the measurement of the RRU fiber transmit time delay of non-current level, and compared with the delay compensation time of the RRU data transmission, it is necessary to reduce the delay time of the RRU fiber transmission of non-current level, and then the air interface synchronization of all levels of RRU.

In an embodiment, as for the downlink synchronous time delay, the method for improving the synchronization precision of data transmission comprises the following steps:

the data frame is transmitted from the signal output port of the BBU to the signal input port of the RRU and buffered;

frame parsing is performed to the wireless frame impulse signal and the carrier data signal of the data frame, and the maximum delay compensation time is set;

delay compensation is performed to the wireless frame impulse signal, according to the transmission and buffering time and the maximum delay compensation time, to generate a radio frequency control signal, which is then sent to the antenna transmit port;

delay compensation is performed to the carrier data signal, according to the transmission and buffering time, the maximum delay compensation time, the DUC (digital up conversion) processing time, the DAC (digital analog conversion) processing time, and the radio frequency module transmission time, and the carrier data goes through DUC processing and DAC processing and then is sent to the antenna transmission port via the radio frequency module; wherein the wireless frame impulse signal and the carrier data signal are sent to the antenna receive port simultaneously.

For the RRU multi-level cascading of downlink synchronous time delay, after the data frame is transmitted from the signal output port of the baseband unit to the signal input port of the RRU and buffered, the data frame of the BBU or previous RRU is transmitted to the next RRU.

In an embodiment, as for the uplink synchronization time delay, the method for improving the synchronous precision of data transmission comprises the following steps:

the data frame is received by the antenna receive port of the RRU, and transmitted to the radio frequency module;

frame parsing is performed to the wireless frame impulse signal and the carrier data signal of the data frame, and the maximum delay compensation time is set;

delay compensation is performed to the wireless frame impulse signal, according to the transmission and buffering time and the maximum delay compensation time, and then buffered to the signal output port of the RRU and transmitted to the signal input port of the BBU;

ADC (analog digital conversion) processing and DDC (digital down conversion) processing are performed to the carrier data signal, and delay compensation is given to the carrier data signal according to the radio frequency module transmission time, the ADC processing time, the DDC processing time, the maximum delay compensation time, and the transmission and buffering time; the carrier data is performed with ADC processing, DDC processing, and then buffered to the signal output port of the RRU and transmitted to the signal input port of the BBU, wherein the wireless frame impulse signal and the carrier data are sent to the signal output port of the RRU simultaneously.

As for the RRU multi-level cascading of uplink synchronization time delay, after the wireless impulse signal and the carrier data signal are buffered to the signal output port of the RRU, the current data frame and the next uplink data frame are performed with framing and transmitted to the previous RRU or BBU. After the wireless frame impulse signal and the current carrier signal form the current data frame, the current data frame and the uplink data frame of next level combine to form an uplink data frame that is transmitted upwards till the BBU.

In an preferred embodiment, the maximum delay compensation time Fixed_Delay is in a range of 0˜10 ms.

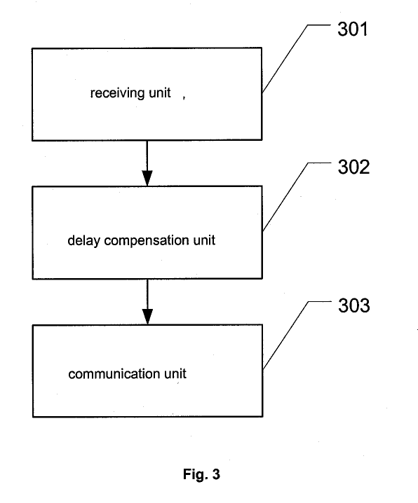

According to the working process and principle of the method of the present invention, a system for improving the data transmission synchronization precision is further provided, the system comprises: a RRU; a BBU for transmitting data frame to the RRU and receiving data frame from the RRU; as shown in FIG. 3, the RRU comprises a receiving unit 301, a delay compensation unit 302, and a communication unit 303.

The receiving unit 301 is used for receiving and buffering the data frame, and frame parsing is performed to the wireless frame impulse signal and the carrier data signal of the data frame. The delay compensation unit 302 is used for performing delay compensation to the wireless frame impulse signal after the frame parsing according to the transmission and buffering time and the maximum delay compensation time, so as to generate a transmission control signal, and also for performing delay compensation to the carrier data signal after the frame parsing, according to the transmission and buffering time, the maximum delay compensation time, and the data processing and transmission time. The communication unit 303 is used for transmitting the wireless frame impulse signal and also for processing and transmitting the carrier data; wherein the wireless frame impulse signal and the carrier data signal are transmitted simultaneously.

In an embodiment, in the delay compensation unit 302, the delay compensation time to the wireless frame impulse signal is equal to the time obtained by subtracting the transmission and buffering time from the maximum delay compensation time; and the delay compensation time to the carrier data signal is equal to the time obtained by subtracting the transmission and buffering time and the data processing and transmission time from the maximum delay compensation time.

As for the RRU multi-level cascading of downlink synchronous time delay, the receiving unit 301 is the signal input port of the RRU, the communication unit 303 comprises the antenna transmission port; as for the RRU multi-level cascading of uplink synchronization time delay, the receiving unit 301 is the antenna transmission port, the communication unit 303 comprises the signal input port of the RRU.

It should be emphasized that the above-described embodiments of the present invention, particularly, any preferred embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method for improving synchronization precision of data transmission, comprising:
receiving and buffering a data frame by a remote radio unit;
performing frame parsing to a wireless frame impulse signal and a carrier data signal of the data frame, and setting the maximum delay compensation time;
performing delay compensation to the wireless frame impulse signal after the frame parsing, according to the transmission and buffering time and the maximum delay compensation time, to generate a transmission control signal, which is then sent to a communication port of the remote radio unit for transmitting;
performing delay compensation to the carrier data signal after the frame parsing, according to the transmission and buffering time, the maximum delay compensation time and the data processing and transmission time, processing the carrier data, and then the carrier data signal being sent to the communication port of the remote radio unit for transmitting; wherein the wireless frame impulse signal and the carrier data signal are sent to the communication port of the remote radio unit simultaneously.

2. The method for improving synchronization precision of data transmission of claim 1, wherein the delay compensation time to the wireless frame impulse signal is equal to the time obtained by subtracting the transmission and buffering time from the maximum delay compensation time; the delay compensation time to the carrier data signal is equal to the time obtained by subtracting the transmission and buffering time and the data processing and transmission time from the maximum delay compensation time.

3. The method for improving synchronization precision of data transmission of claim 2, wherein:
the data frame is transmitted from the signal output port of the baseband unit to the signal input port of the remote radio unit and buffering;
frame parsing is performed to the wireless frame impulse signal and the carrier data signal of the data frame, and the maximum delay compensation time is set;
delay compensation is performed to the wireless frame impulse signal, according to the transmission and buffering time and the maximum delay compensation time, to generate a radio frequency control signal, which is then sent to the antenna transmit port;
time compensation is performed to the carrier data signal, according to the transmission and buffering time, the maximum delay compensation time, the digital up conversion processing time, the digital analog conversion processing time, and the radio frequency module transmission time, and digital up conversion processing and digital analog conversion processing are performed to the carrier data, and then the carrier data is sent to the antenna transmission port via the radio frequency module; wherein the wireless frame impulse signal and the carrier data signal are sent to the antenna receive port simultaneously.

4. The method for improving synchronization precision of data transmission of claim 3, wherein after the data frame is transmitted from the signal output port of the baseband unit to the signal input port of the remote radio unit and buffering, the data frame of the baseband unit or the previous remote radio unit is transmitted to the next remote radio unit.

5. The method for improving synchronization precision of data transmission of claim 2, wherein:
the data frame is received by the antenna receive port of the baseband unit, and transmitted to the radio frequency module;
frame parsing is performed to the wireless frame impulse signal and the carrier data signal of the data frame, and the maximum delay compensation time is set;
delay compensation is performed to the wireless frame impulse signal, according to the time for the data frame to be transmitted and buffered to the baseband unit and the maximum delay compensation time, and then the wireless frame impulse signal is buffered to the signal output port of the remote radio unit and transmitted to the signal input port of the baseband unit;
analog digital conversion processing and digital down conversion processing are performed to the carrier data signal; delay compensation is performed to the carrier data signal according to the radio frequency module transmission time, the analog digital conversion processing time, the digital down conversion processing time, the maximum delay compensation time and the transmission and buffering time; analog digital conversion processing and digital down conversion processing are performed to the carrier data which is then buffered to the signal output port of the remote radio unit and transmitted to the signal input port of the baseband unit; wherein the wireless frame impulse signal and the carrier data are sent to the signal output port of the remote radio unit simultaneously.

6. The method for improving synchronization precision of data transmission of claim 5, wherein after the wireless impulse signal and the carrier data signal are buffered to the signal output port of the remote radio unit, framing is performed to the current data frame and the next uplink data frame, and transmitted to the previous remote radio unit or the baseband unit.

7. The method for improving synchronization precision of data transmission of claim 1, wherein the maximum delay compensation time is in a range of 0-10 ms.

8. A system for improving synchronization precision of data transmission, comprising:
a remote radio unit; and
a baseband unit for transmitting data frame to the remote radio unit and receiving data frame from the remote radio unit;
wherein the remote radio unit comprises:
a receiving unit for receiving the data frame and buffering and performing frame parsing to the wireless frame impulse signal and the carrier data signal of the data frame;
a delay compensation unit for performing delay compensation to the wireless frame impulse signal after the frame parsing, according to the transmission and buffering time and the maximum delay compensation time, and also for performing delay compensation to the carrier data signal after the frame parsing, according to the transmission and buffering time, the maximum delay compensation time and the data processing and transmission time; and
a communication unit for transmitting the wireless frame impulse signal and also for processing and transmitting the carrier data; wherein the wireless frame impulse signal and the carrier data signal are transmitted simultaneously.

9. The system for improving synchronization precision of data transmission of claim 8, wherein in the delay compensation unit, the delay compensation time to the wireless frame impulse signal is equal to the time obtained by subtracting the transmission and buffering time from the maximum delay compensation time; and the delay compensation time to the carrier data signal is equal to the time obtained by subtracting the transmission and buffering time and the data processing and transmission time from the maximum delay compensation time.

10. The system for improving synchronization precision of data transmission of claim 8, wherein the receiving unit is the signal input port of the remote radio unit, the communication unit comprises the antenna transmission port; alternatively, the receiving unit is the antenna transmission port, the communication unit comprises the signal input port of the remote radio unit.
